(19) United States
(12) Patent Application Publication
(10) Pub. No.: US 2003/0130102 A1
(43) Pub. Date: Jul. 10, 2003

(54) Packaging material

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/383,200

(22) Filed: Mar. 6, 2003

Related U.S. Application Data
(63) Continuation of application No. 10/012,146, filed on Dec. 7, 2001.
Application No. 10/012,146 is a division of application No. 09/664,645, filed on Sep. 19, 2000.

(51) Int. Cl. B31F 5/02

(52) U.S. Cl. 493/350

(57) ABSTRACT

A packaging material comprising a plurality of thimble shaped cushioning members for cushioning an article in a container is provided. The cushioning members are formed into a predetermined shape having a closed lower end, a tubular sidewall, and an opened upper end. The cushioning members are formed of a flexible sheet of material having an upper surface and a lower surface with at least one of the upper surface and the lower surface being a bondable surface. The cushioning members are formed to have a plurality of overlapping folds formed between the opened upper end and the closed lower end such that the overlapping folds are fixed to retain the cushioning members in the predetermined shape.

### CROSS-REFERENCE TO RELATED APPLICATIONS

This application is a continuation of U.S. Ser. No. 10/012,146, filed Dec. 7, 2001, entitled “PACKAGING MATERIAL,” which is a divisional of U.S. Ser. No. 09/664,645, filed Sep. 19, 2000, entitled “PACKING MATERIAL,” the contents of all of which are hereby expressly incorporated herein by reference in their entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to packaging materials for packaging articles, and more particularly, but not by way of limitation, to a packaging material comprising a plurality of cushioning members formed of a flexible sheet of material fixed in a predetermined shape.

2. Brief Description of the Related Art

In the process of shipping an article from one location to another, the article is typically placed in a container along with a protective packaging material to fill the voids about the article and to cushion the article during the shipping process. One common protective packaging material is comprised of a plurality of plastic foam, peanut-shaped members which are commonly known as “styrofoam peanuts.” One advantage in using styrofoam peanuts is the ease with which they may be disposed about an article positioned in a container by simply pouring the styrofoam peanuts from a dispenser.

While styrofoam peanuts have been widely accepted in the packaging industry, they are not without disadvantages, the most serious of which is their effect on the environment. That is, polystyrene peanuts are not biodegradable and thus further already critical waste disposal problems. The non-biodegradability of these packaging materials has become increasingly important in light of many industries adopting more progressive policies in terms of environmental responsibility.

This and other disadvantages of styrofoam peanuts has made paper protective packaging material a popular alternative in that paper is biodegradable, recyclable and renewable. In the past, attempts have been made to develop paper cushioning members which have the same flowability as styrofoam peanuts. For example, U.S. Pat. No. 4,997,091, issued to McCrea, discloses pellet-shaped cushioning members which are produced by extruding paper pulp. The problem with the McCrea process is that it includes complicated pulping and extruding steps.

An example of a paper cushioning member which is intended to have the flowability of styrofoam peanuts is disclosed in U.S. Pat. No. 5,568,867, issued to Lencoski. More specifically, Lencoski teaches a thimble shaped cushioning product formed from a sheet of paper. The cushioning product is formed by inserting a punch through a die with a sheet of paper positioned therebetween so as to form the sheet of paper into the thimble shaped cushioning product. The cushioning product includes a closed lower end, an open upper end, and a tubular sidewall having a plurality of overlapping folds formed therein. The problem encountered in the use of the paper cushioning product of Lencoski is that the flexibility of the paper results in the cushioning product not being able to retain its shape when subjected to compressive stresses. Thus, the cushioning products are easily crushed and deformed whereby voids can develop about the packed article during the shipping process and the resiliency of cushioning effect provided by the cushioning products can quickly deteriorate.

To this end, an improved packaging material is needed which is easily manufactured from a sheet of flexible material and which is capable of retaining a predetermined shape when subjected to compressive stresses. It is to such a packaging material that the present invention is directed.

### BRIEF SUMMARY OF THE INVENTION

The present invention is directed to a cushioning member for use as a packaging material. The cushioning member is formed into a predetermined shape having a lower end, an upper end, and a sidewall from a flexible sheet of material. A plurality of overlapping folds are formed in the sidewall which extend between the upper end and the lower end of the cushioning member. The sheet of material is characterized as having an upper surface and a lower surface with at least one of the upper surface and the lower surface being a bondable surface such that the overlapping folds are bondably connected to retain the cushioning members in the predetermined shape.

The present invention also provides a method making a cushioning member which generally includes the steps of providing a sheet of material having at least one bondable surface and forming the sheet of material into a thimble-shaped member. More particularly, the method includes the steps of providing a die and a complimentary punch, positioning the sheet of material over the die, and driving the punch through the die to form the sheet of material into the desired shape of the cushioning member and to bondingly connect the overlapping folds created in the sheet of material.

A plurality of the cushioning members may be incorporated into a package which additionally includes a container and an article positioned within the container. The cushioning members may be poured from a dispenser into the container and will substantially surround the article positioned within the container. In this manner, the cushioning members will function as a protective packaging material which cushions the article during a shipping process.

The objects, features and advantages of the present invention will become apparent from the following detailed description when read in conjunction with the accompanying drawings and appended claims.

### BRIEF DESCRIPTION OF THE SEVERAL VIEWS OF THE DRAWING

FIG. 1 is a perspective view of a cushioning member constructed in accordance with the present invention.

FIG. 2 is a perspective view of a sheet of material for use in forming the cushioning member of FIG. 1.

FIG. 3 is a sectional view of a portion of the cushioning member of FIG. 1 illustrating the connection of some of the overlapping folds.

FIG. 4 is a schematic illustration of a method of making a cushioning member constructed in accordance with the present invention.

FIG. 5 is a perspective view of another cushioning member constructed in accordance with the present invention.

FIG. 6 is a perspective view of a sheet of material for use in forming the cushioning member of FIG. 5.

FIG. 7 is a perspective view of a package incorporating a plurality of cushioning members constructed in accordance with the present invention.

### DETAILED DESCRIPTION OF THE INVENTION

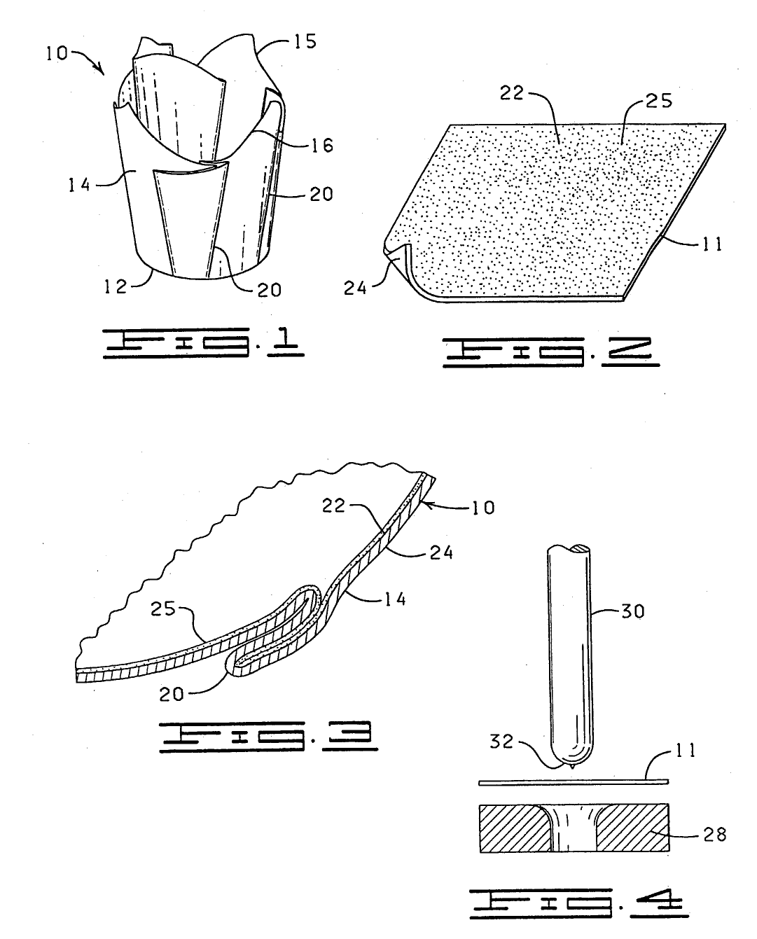

Referring now to the drawings, and more particularly to FIGS. 1 and 2, a cushioning member 10 constructed in accordance with the present invention is illustrated in FIG. 1. The present invention particularly contemplates the cushioning member 10 being formed into a predetermined shape from a flexible sheet of material 11 (FIG. 2). Typically, the sheet of material 11 is constructed of a polygonal piece of the paper. More preferably, however, the sheet of material 11 comprises a substantially square sheet of material which is approximately 1½ to 2 inches in length and 1½ to 2 inches in width. The sheet of material 11 may be constructed of a single layer of material or a plurality of layers of the same or different types of materials. In addition, any thickness of the sheet of material 11 may be utilized with the present invention so long as the sheet of material 11 is shapeable into the cushioning member 10.

Although the sheet of material 11 shown in FIG. 2 is square, the sheet of material 11 may be any shape. For example, the sheet of material 11 may be square, rectangular, circular or any other geometric shape. The shape of the sheet of material 11 may even have an irregular, capricious or decorative shape.

The cushioning member 10 is generally thimble-shaped in that the cushioning member 10 has a generally cup-shaped geometry which is roughly sized to be inserted over a individual's finger tip. The cushioning member 10 has a relatively flat, closed lower end 12, a tubular sidewall 14 extending therefrom, and an open upper end 15. In one embodiment, the lower end 12 is circular and approximately ½ inch to 1 inch in diameter. Additionally, the sidewall 14 is approximately ½ inch to 1 inch in length. The peripheral edge of the sheet of material 11 forms a circumferential rim 16 which has a jagged configuration due to the square shape of the sheet of material 11.

As shown in FIGS. 1 and 3, the sidewall 14 of the cushioning member 10 includes a plurality of overlapping folds 20 that are bondably connected (only some of the overlapping folds 20 being designated by a reference numeral in the drawings). Substantial portions of the overlapping folds 20 extend at angles generally to a vertical direction with the various angles being arbitrary and varying from one overlapping fold 20 to another overlapping fold 20. The overlapping folds 20 are formed at various positions about the sidewall 14 and extend from the lower end 12 to the upper end 15. The overlapping folds 20, while providing a decorative appearance to the cushioning member 10, more significantly provide a mechanical strength to the sidewalls 14 for enabling the cushioning member 10 to substantially retain its thimble shape when the overlapping folds 20 are connected. In this manner, the cushioning member 10 has sufficient mechanical strength to substantially retain its shape when subjected to compressive forces. Significantly, connection of the overlapping folds 20 permits relatively thin sheets of material 11 to be utilized to form the cushioning member 10.

The sheet of material 11 illustrated in FIG. 2 has an upper surface 22 and a lower surface 24 and a bonding material 25 disposed on the upper surface 22. It will be appreciated that either the upper surface 22, the lower surface 24, or both the upper surface 22 and the lower surface 24 can be provided with the bonding material 25 so that when portions of the sheet of material 11 are brought into bondable contact, such portions are bondably connected.

The overlapping folds 20 of the cushioning member 10 are formed by overlapping portions of the sheet of material 11 and bringing such overlapping portions into bondable engagement or contact. In this manner, the overlapping folds 20 are permanently fixed in the cushioning member 10. When an overlapping fold 20 is formed in a portion of the sheet of material 11 during the forming of the cushioning member 10, portions of the upper surface 22 are overlapped and brought into bondable contact or engagement and, with respect to the same overlapping fold 20, portions of the lower surface 24 also are overlapped and brought into bondable contact or engagement.

At least one of the upper and the lower surfaces 22 and 24 is prepared to form a bondable surface which is adapted to be bonded to portions of a similar bondable surface when bondably contacted with a similar bondable surface portion. Thus, in those instances when only the lower surface 24 is prepared to form a bondable lower surface 24, the overlapping portions of the bondable lower surface 24 are brought into bondable contact during the forming of the cushioning member 10 and such overlapping portions are bonded to form the overlapping folds 20. The corresponding overlapping portions of the upper surface 22 are not bonded. Similarly, in those instances when only the upper surface 22 is prepared to form a bondable upper surface 22, the overlapping portions of the bondable upper surface 22 are brought into bondable contact during the forming of the cushioning member 10 and such overlapping portions are bonded to form the overlapping folds 20. The corresponding overlapping portions of the lower surface 24 are not bonded. Finally, in those instances when both the upper and the lower surfaces 22 and 24 are prepared to form bondable upper and lower surfaces 22 and 24, the overlapping portions of the upper and the lower surfaces 22 and 24 forming each overlapping fold 20 are brought into bondable contact during the forming of the cushioning member 10 and such overlapping portions of the upper and the lower surfaces 22 and 24 are bonded to form the overlapping folds 20.

It will be appreciated that it is necessary to prepare only one of the upper and the lower surfaces 22 or 24 to form a bondable surface so that the cushioning member 10 is formable from the sheet of material 11 having sufficient mechanical strength to retain its formed shape in accordance with the present invention. However, it should be noted that preparing both the upper and the lower surfaces 22 and 24 to form bondable surfaces provides additional mechanical strength which may be desired in some applications and particularly in those applications where the additional mechanical strength is needed to enable the formed cushioning member 10 to maintain or retain its formed shaped. Such additional strength may be desired either because of the articles being packaged or the particular thickness or characteristics of the particular material forming the sheet of material 11.

Various techniques can be utilized to prepare the sheet of material 11 with at least one bondable surface in accordance with the present invention. One technique for preparing the bondable surfaces is to apply a coat of a suitable cohesive to the upper surface 22, the lower surface 24, or both the upper surface 22 and the lower surface 24 so that overlapping portions of the sheet of material 11 are cohesively connected when the overlapping folds 20 are formed in the sheet of material 11.

Another technique for preparing the bondable surfaces is to apply a suitable pressure sensitive adhesive to either the upper surface 22 or the lower surface 24, or both the upper surface 22 and the lower surface 24 so that overlapping portions of the sheet of material 11 are adhesively connected when the overlapping folds 20 are formed in the sheet of material 11.

It should be noted that a light activated adhesive also is suitable for use in preparing the bondable surface in accordance with the present invention. In this instance, means for lighting the areas to be bonded would be necessary which might be effected by utilizing a light source during the forming of the cushioning members 10.

Another technique for preparing the bondable surfaces is to apply a heat sealable coating to either the upper surface 22 or the lower surface 24, or both. The heat sealable coating also can be a heat sealable lacquer, a pressure sensitive adhesive which also requires heat to effect the bond, or a non-melt adhesive.

It will be appreciated that as an alternative to coating the entire upper surface 22, the lower surface 24, or both the upper surface 22 and the lower surface 24 of the sheet of material 11, the bonding material 25 may be applied to one or both of the surfaces of the sheet of material 11 in the form of a plurality of parallel or perpendicular strips, a circumferential strip, spaced apart spots or in any other pattern or geometric form.

It will be further appreciated that the resiliency and other functional characteristics of the cushioning member 10 can be varied depending on the surface of the sheet of material 11 the bonding material 25 is applied to, the pattern in which the bonding material 25 is applied, and the tackiness of the bonding material 25 used. For example, if the bonding material 25 is applied to the upper surface 22 of the sheet of material 11 so as to coat the entire upper surface 22, as shown in FIG. 2, and the sheet of material 11 is formed into the cushioning member 10 so that the upper surface 22 of the sheet of material 11 forms the interior surface of the cushioning member 10, opposing portions of the cushioning member 10 may have a tendency to undesirably bond when a crushing force is applied to the cushioning member 10. The use of bonding materials with a lesser degree of tack can alleviate this concern, as well as the application of the bonding material to less than the entire upper surface 22 of the sheet of material 11, such as in the form of strips, spots, and the like. Also, while it is necessary that the cushioning member 10 have a certain degree of resiliency, the use of stiffer bonding material can increase the rigidity of the cushioning member 10 and thus reduce the likelihood of the cushioning member 10 collapsing and bonding to itself.

If the bonding material 25 is applied to the lower surface 24 of the sheet of material 11 so as to coat the entire lower surface 24, and the sheet of material 11 is formed into the cushioning member 10 so that the lower surface 24 of the sheet of material 11 forms the exterior surface of the cushioning member 10, adjacent cushioning members 10 may have a tendency to bond or stick together. Again, the use of bonding material with a lesser degree of tack, as well as the application of the bonding material to less than the entire lower surface 24 of the sheet of material 11, such as in the form of strips, spots, and the like, can alleviate this condition if it is undesirable. In some instances, however, it may be desirable for the cushioning members 10 to adhere to one another to form a cohesive cushioning unit. The formation of such a cohesive unit can reduce the mess associated with scattering of loose or flowable packing material and prevent an article surrounded by the cohesive unit from gravitating through the cushioning members 10, as can be experienced with the use of loose packing materials.

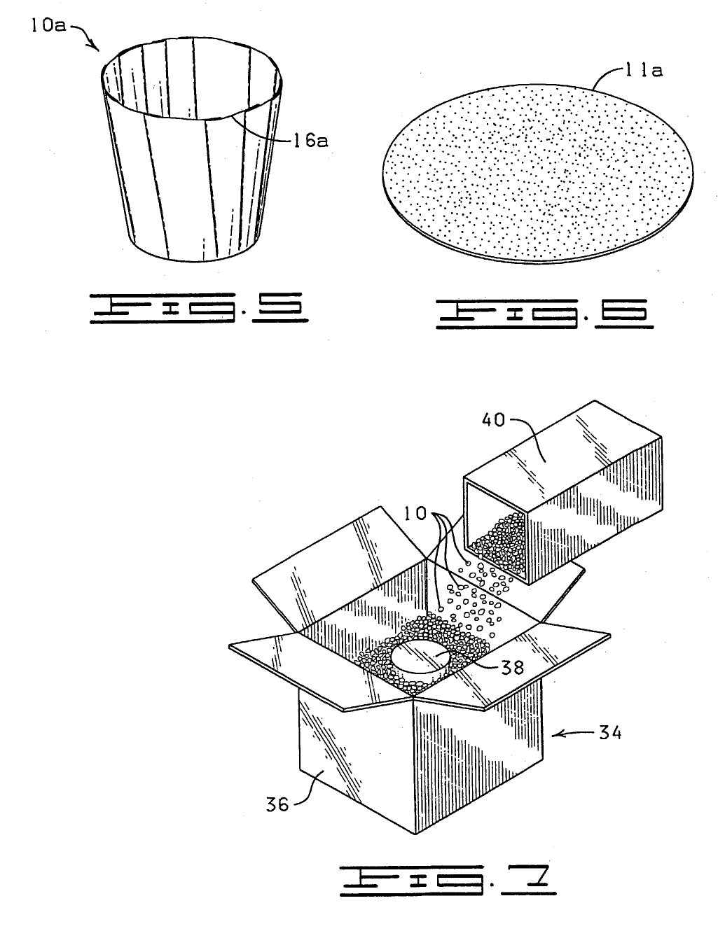

Referring now to FIG. 4, a method of making a cushioning member 10 constructed in accordance with the present invention is schematically shown. This method generally includes the steps of providing the sheet of material 11 and forming the sheet of material 11 into a thimble shape. More particularly, the method includes the steps of providing the sheet of material 11, providing a die 28 and a complementary punch 30, positioning the sheet of material 11 over the die 28, and driving the punch 30 through the die 28 to form the sheet of material 11 into the cushioning member 10 and to bondably connect the overlapping folds 20 created in the sheet of material 11. Thereafter, the punch 30 is retracted from the die 28 with the formed cushioning member 10 attached thereto and the formed cushioning member 10 is stripped from the retracted punch 30 for use as a packaging material.

The die 28 is a circular die having an approximately ½ inch to 1 inch diameter, and the punch 30 is preferably a cylindrical punch with a rounded driving end 32. The die 28 preferably has a polished surface, and the punch 30 preferably has a textured surface. In this manner, the sheet of material 11 will slip freely through the die 28, but it will not migrate up the punch 30 during the forming process.

FIGS. 5 and 6 illustrate another cushioning member 10a formed from a sheet of material 11a. The cushioning member 10a is formed in a manner identical to that described above in reference to the cushioning member 10 with the exception that the sheet of material 11a has a circular configuration. As such, the peripheral edge of the sheet of material 11a forms a generally smooth or non-jagged circumferential rim 16a when the sheet of material 11a is formed into the cushioning member 10a.

In forming the cushioning member 10 and 10a, each may be formed from a sheet of material commonly referred to as a “film”. More particularly, the sheet of material 11 and 11a can be fabricated of a polyvinyl chloride film which is heat sealable.

When utilizing a heat sealable film, the upper and the lower surfaces of the sheet of material are bondable surfaces and the sheet of material must be heated during the forming of the cushioning member 10 or 10a, and more particularly, during the forming of overlapping folds 20 or 20a to effect heat sealable bonding of the contacting surfaces. This can be achieved by heating the die 28 and the punch 30 in a manner similar to that disclosed in U.S. Pat. No. 4,773,182, issued to Weder et al. on Jan. 5, 1987, which is hereby expressly incorporated herein by reference.

Referring now to FIG. 7, a plurality of the cushioning members 10 are shown incorporated into a package 34. The package 34 includes a container 36 and an article 38 positioned within the container 36. The cushioning members 10 may be poured from a dispenser 40 into the container 36 so as to substantially surround the article 38 positioned within the container 36. In this manner, the cushioning members 10 will function as a protective packaging material filling voids about the article 38 and cushioning the article 38 during a shipping process.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. An improved method for cushioning an article in a container with a plurality of cushioning members placed in the container to substantially surround at least a portion of the article to provide a protective cushion for the article, each of the cushioning members formed from a flexible sheet of material having an upper surface and a lower surface and formed into a cup-shaped member having a lower end, an upper end, and a sidewall with a plurality of overlapping folds extending between the upper end and the lower end, the improvement comprising the steps of:
bondably connecting at least a portion of the overlapping portions of the folds to retain the cup shape of the cushioning member prior to placing the cushioning members in the container.

2. The method of claim 1 wherein the overlapping portions of the folds are bondably connected with an adhesive.

3. The method of claim 1 wherein the overlapping portions of the folds are bondably connected with a pressure sensitive adhesive.

4. The method of claim 1 wherein the overlapping portions of the folds are bondably connected with a light sensitive adhesive.

5. The method of claim 1 wherein the overlapping portions of the folds are bondably connected with a cohesive.

6. A method for packaging an article in a container with a plurality of cushioning members which function as a protective packaging material, each of the cushioning members formed from a flexible sheet of material having an upper surface and a lower surface and formed into a cup-shaped member having a lower end, an upper end, and a sidewall with a plurality of overlapping folds extending between the upper end and the lower end, the method comprising the steps of:
applying a bonding material to at least one of the upper and lower surfaces of the sheet of material;
bondably connecting at least a portion of the overlapping portions of the folds to retain the cup shape of the cushioning member;
placing the cushioning members in the container; and
placing the article in the container so that the cushioning members substantially surround the article.

7. The method of claim 6 wherein the bonding material is an adhesive.

8. The method of claim 7 wherein the adhesive is a pressure sensitive adhesive.

9. The method of claim 7 wherein the adhesive is a light sensitive adhesive.

10. The method of claim 6 wherein the bonding material is a cohesive.

11. An improved method of forming a cushioning member for use as a packaging material of the type formed from a flexible sheet of material having an upper surface and a lower surface and formed into a cup-shaped member having a lower end, an upper end, and a sidewall with a plurality of overlapping folds extending between the upper end and the lower end, the improvement comprising the steps of:
applying a bonding material to at least one of the upper and lower surfaces of the sheet of material; and
bondably connecting at least a portion of the overlapping portions of the folds to retain the cup shape of the cushioning member.

12. The method of claim 11 wherein the bonding material is an adhesive.

13. The method of claim 12 wherein the adhesive is a pressure sensitive adhesive.

14. The method of claim 12 wherein the adhesive is a light sensitive adhesive.

15. The method of claim 11 wherein the bonding material is a cohesive.
